(19) United States
(12) Patent Application Publication
(10) Pub. No.: US 2003/0028640 A1
(43) Pub. Date: Feb. 6, 2003

(54) Peer-to-peer distributed mechanism

(76) Inventor: Vishal Malik, Sunnyvale, CA (US)

Correspondence Address: Hewlett-Packard Company, Intellectual Property Administration, P.O. Box 272400, Fort Collins, CO, 80527-2400, US

(21) Appl. No.: 09/916,268

(22) Filed: Jul. 30, 2001

(51) Int. Cl. G06F 15/173

(52) U.S. Cl. 709/226; 709/208; 709/102

(57) ABSTRACT

A method of dynamically allocating network resources including a plurality of computers receiving a request for networked resources is described. A determination is made whether a sub-broker can handle the request. If no sub-broker can handle the request, then the request is rejected. If a sub-broker can handle the request, a peer after qualification is prepared for handling the request. The request is then provided to the peer for execution.

### FIELD OF THE INVENTION

The present invention relates generally to peer-to-peer distributed architectures, and more particularly, to a peer-to-peer distributed architecture having computers that have traditionally been used solely as clients which can act as both clients and servers, assuming whatever role is most efficient for the network.

### BACKGROUND OF THE INVENTION

In a client-server environment, there are instances when servers are overloaded, yet there are clients with additional capacity. This is shown in the following example.

A machine (called peer herein) is pre-prepared (pre-configured) to perform a specified task and hence led to the queuing of requests that requested a “different” task to be performed other than the machine was configured to do.

| REQUESTS | MACHINES |
|---|---|
| Request-1: Perform task X | Machine-A: performs task X |
| Request-2: Perform task Y | Machine-B: performs task Y |
| Request-3: Perform task X | Machine-C: performs task Z |

In the above scenario, Request-1 will be assigned Machine-A to perform task X. The rest of the requests viz. Request-2 would be assigned Machine-B to perform task Y and Request-3 for performing task X would wait as Machine-A is the only machine that performs task X. And so, Machine-C would sit idle and would not be used.

Typographically, it will be as follows:

Request-1: Machine-A

Request-2: Machine-B

Request-3: Wait for Machine-A

Machine-C: sits idle waiting for task Z to arrive. If not, it will sit idle.

As a specific example consider that currently, there is no centralized test facility for testing code changes related to commands and libraries. The lack of such a facility greatly impacts the quality of code submitted by a patch or a future version release. Because of this, manual testing must be performed and machines must be configured prior to testing. Thus, testing requests must wait for machines to be prepared and configured for the test requested, as described above, and machines configured for a particular test sit idle waiting for an appropriate test request. This is a large waste of computing resources. Further, machines are typically dedicated to a particular project and the resources are not shared for testing. Therefore, the computing waste is multiplied by the multitude of projects and further increased.

Thus, there is a need in the art for a dynamically configurable networked resource allocation mechanism, and more specifically, for such a mechanism to be usable in a peer-to-peer distributed architecture.

### SUMMARY OF THE INVENTION

It is an object of the present invention to provide a dynamically configurable networked resource allocation mechanism.

It is a further object of the present invention to provide a dynamically configurable networked resource allocation mechanism usable in a peer-to-peer distributed architecture.

These and other objects of the present invention are achieved by a method of dynamically allocating network resources including a plurality of computers receiving a job request for networked resources. It determines whether a sub-module can handle the job request and, if no sub-module can handle the job request, then the request is rejected. If a sub-module can handle the request, a computer having available resources to handle the job request is prepared. Alternatively, the job request is matched to a computer having available resources and configured to handle the job request.

The foregoing and other objects of the present invention are also achieved by a system for dynamically allocating network resources, including a plurality of computers. A master broker resides on one of the plurality of computers, a sub-broker resides on another one of the computers, and there is at least one peer from the plurality of computers. The master broker is capable of receiving a job request and determining whether a sub-broker can handle the job request. If a sub-broker can handle the job request, then the machine is prepared to perform the job request.

Advantageously, the present invention provides parallelism and load distribution by enhancing tests, e.g., commands and libc tests, to run in parallel thus reducing the time to finish a particular request. It will provide load distribution by running pieces of tests (commands and libraries) on different machines thus distributing processing/computational requests across multiple computers and hence servicing a request in a much faster manner. The results are faster completion times and lower cost because the technology takes advantage of available processing time on client systems.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompany drawings, wherein elements having the same reference numeral designations represent like elements throughout and wherein:

FIG. 1 is a logical architecture of a distributed peer-to-peer mechanism according to the present invention;

FIG. 2 is a diagram illustrating the distributed peer-to-peer mechanism in greater detail;

FIG. 3 is a diagram illustrating the global machine pool list in greater detail;

FIG. 4 is a flow diagram of a request from a master broker;

FIG. 5 is a diagram illustrating the global resource allocation;

FIG. 6 is an illustration of patch processing by a sub-broker;

FIG. 7 is a high level block diagram of a computer system usable with the present invention;

FIG. 8 is a flow diagram of a request from a user to a peer; and

FIG. 9 is a flow diagram of a request as handled by the present invention.

### BEST MODE FOR CARRYING OUT THE INVENTION

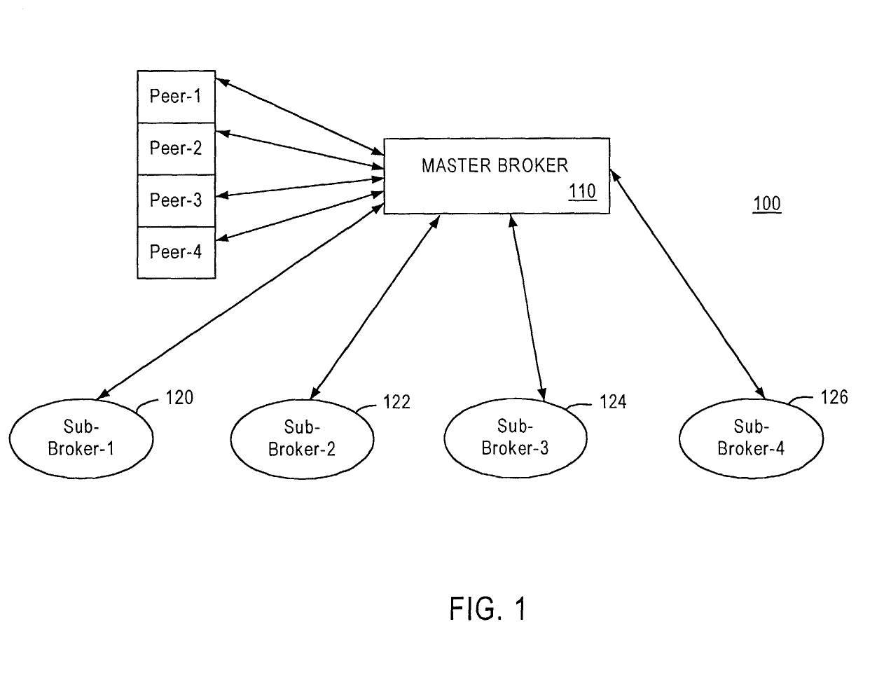

Refer now to FIG. 1, which illustrates a distributed peer allocation system 100 according to the principles of the present invention. As depicted in FIG. 1, a master broker 110 is in two-way communication with each peer-1, peer-2, peer-3 and peer-4. The master broker 110 is also in two way communication with a sub-broker-1 (120), a sub-broker-2 (122), a sub-broker-3 (124) and a sub-broker-4 (126). It should be appreciated that although four peers and four sub-brokers are illustrated, any number of either can be used in the present invention. There is no limitation on the number of sub-brokers or peers connected to a master broker. There may be more than one master broker. It is linear in that way and hence there is no penalty for adding more systems/peers to the distributed network.

The peer-to-peer distributed mechanism 100 also allows computing networks to dynamically work together using intelligent agents. Agents can either reside on sub-broker computers or peer computers and communicate various kinds of information back and forth. Agents may also initiate tasks on behalf of other peer systems. For instance, intelligent agents can be used to prioritize tasks on a network, change traffic flow, search for files locally or determine anomalous behavior such as a virus and stop it before it affects the network.

The present invention provides a set of independently pluggable modules to be used as the basis for improving quality of code changes to HP-UX commands, Linux commands on HP-UX and HP-UX libc. The master broker 110, the sub-brokers 120-126 and the intelligent agents residing on peers 1-4 are each independently pluggable modules.

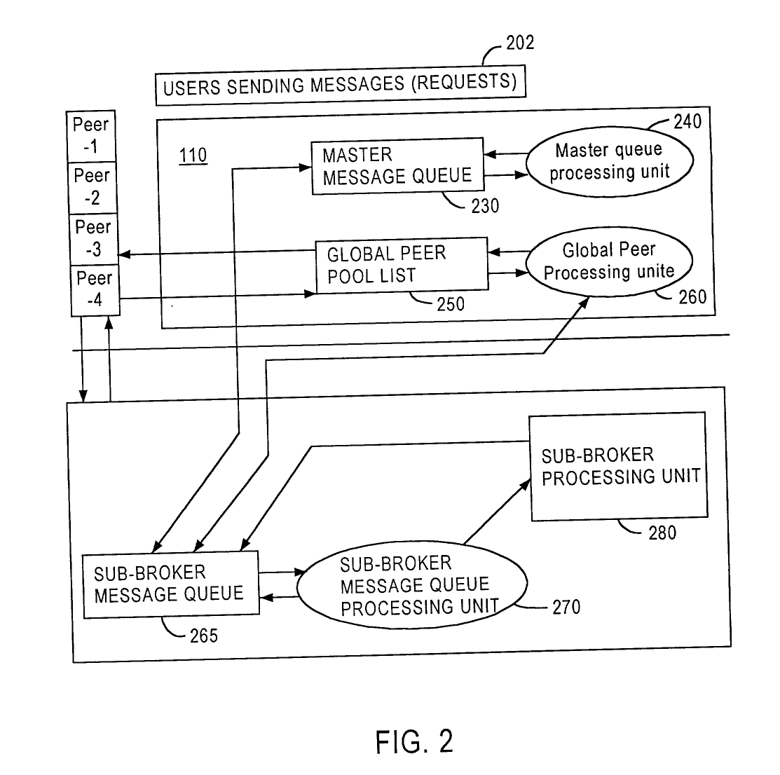

Referring again to FIG. 1 where a logical architecture of an allocating, testing and reconfiguration system is depicted according to the principles of the present invention. The master broker 110 and the sub-broker 120 are illustrated in greater detail in FIG. 2. Only one sub-broker 110 is illustrated for clarity. As depicted in FIG. 1, users can send messages (request) at 202. The master broker 110 includes a master message queue 230, a master queue processing unit 240, a global peer pool list 250 and a global peer processing unit 260.

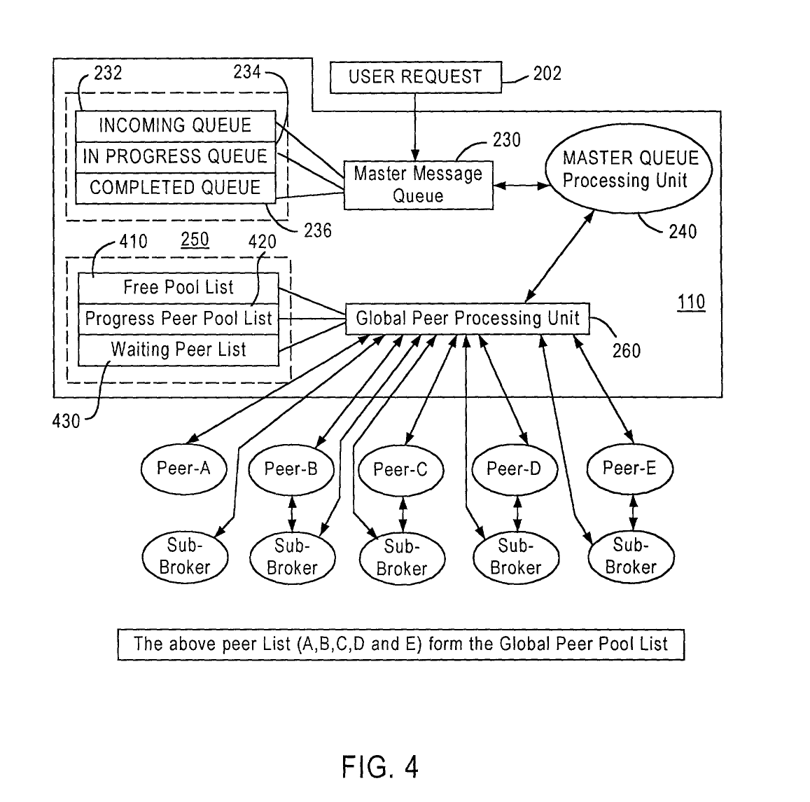

The master message queue 230 is where the requests are queued when a user request 202 is received. The master message queue 230 includes a list of requests received from a user. The master message queue 230 in turn is composed of three queues: an incoming request queue 232, an in-progress request queue 234, and a completed request queue 236 (see FIG. 4).

When a request arrives, it is sent to the incoming request queue 232 and when the global peer processing unit 260 assigns a peer to the request, it sends the request to the master queue processing unit 240 which then moves the request to in-progress request queue 234. When a peer finishes a request, it sends a message to the global peer processing unit 260 which in turn sends a message to the master queue processing unit 240 and hence moves the request from in-progress request queue 234 to the completed request queue 236.

The master queue processing unit 240 picks up the request as soon as the request arrives inside the master broker 110, i.e., submitted to the master broker 110, and identifies the request as one which a sub-broker 120 can perform.

For example, if there is no sub-broker that can do a task A, then this request is rejected by the master broker upon getting a message/reply from the master queue processing unit 240. When a sub-broker 120 registers itself to the master broker 110, it is the master queue processing unit 240 that keeps track of what kinds of sub-brokers are available in the distributed system 100 in order for it to accept related requests.

The global peer pool list 250 includes a list of peers participating in the distributed network 100. The global peer pool list 250 in turn is composed of three lists: a free peer list 410, an in-progress peer list 420 and a waiting peer list 430 (see FIG. 4). The free peer list 410 has a list of peers that can be allocated to run a particular request. The in-progress peer list 420 has a list of peers that are at present running a particular request. The waiting peer list 430 has a list of peers which just have been returned from the sub-broker after running a request and after “qualification”, the peers get added to the free peer list 410. Peer qualification means making sure the peer is in a state where it has no hardware or software failures after running a particular request and to make sure the peer is ready/can be “prepared”.

Peer preparation means installing the correct release of the operating system as required by the request submitted by the user and installing the latest test sources to run against the request. In one embodiment, a check is performed to see if the latest operating system and test sources are installed.

The global peer processing unit 260 registers peers becoming part of the global peer processing list. The global peer processing unit functionality is to add peers when the peer becomes available (after a request is finished by a sub-broker 120) to the waiting peer list. After that, the global peer processing unit 260 adds the peers to the free peer list 410 ready to be prepared to perform a run a particular request. The global peer processing unit 260 forms a pair request:peer and then removes the peer from the free peer list 410 and moves it to the in-progress peer list 420. The global peer processing unit functionality is to match a request with the list of peers (machines) inside the global peer pool list 250. Once the request is qualified, then a match can occur. Once a peer is returned back to the global peer pool list 250 from the sub-broker 120, the peer is again qualified and then “prepared” by the global peer processing unit 260 to perform another similar or different task. If the task is similar, the global peer processing unit 260 would still prepare the peer to perform that same task. So the global peer processing unit 260 will not “RE-USE” the peer even if the first and second requests are the same. This maintains the integrity of the peer in terms of any changing any known state left behind by a previous request even if it was the same request. Any peer that gets registered also goes to the waiting peer list 430.

For example, the global peer processing unit 260 performs the following interaction with the global peer pool list 250. When a request arrives at the global peer processing unit 260, it then moves a peer from the free peer pool list 410 and moves it to in-progress peer pool list 420 and at the same time sends the request:peer pair to the sub-broker 120. After the tests are finished running, the peer sends a request back to the global peer processing unit 260 which then moves the peer from the in-progress peer pool list 420 queue to the waiting peer pool list 430. It also sends a message to the mater queue processing unit 240 which then moves the request from the in-progress queue 234 to the completed request queue 236.

Referring back to FIG. 2, each of the sub-brokers 120 includes a sub-broker message queue 265, a sub-broker message queue processing unit 270 and a sub-broker processing unit 280. The sub-broker message queue 265 is where request:peer pairs related to this sub-broker are queued. The request:peer pair is generated by the master queue processing unit 240 and sent to the sub-broker message queue 265 through the global peer processing unit 260. The request:peer pair from global peer processing unit 260 is sent to the sub-broker message queue 265. The sub-broker message queue processing unit 270 picks the request:peer pair from the sub-broker message queue 265 and makes sure the request is “correct/qualified” and can be run by this sub-broker and then forwards it to the sub-broker processing unit 280.

The sub-broker processing unit 280 communicates with the master broker 110, peer and also the intelligent agent. The sub-broker processing unit 280 functionality is to monitor the progress of a request running on a peer and when it is finished, the peer is returned back to the waiting peer list 430. The sub-broker processing unit 280 communicates with the intelligent agent that can be either part of the sub-broker or a separate peer performing as an intelligent agent. The sub-broker processing unit 280 interfaces with the intelligent agent to identify which request:peer pair coming from the master broker can be divided into smaller requests so that instead of needing one peer, it would need two peers. This is where the load balancing is done (within each sub-broker).

In a particular example of sub-broker processing unit 280 functionality, the sub-broker processing unit 280, based on the request:peer pair, picks up a binary command or a kernel binary and builds a kernel and installs it on the peer. The sub-broker processing unit 280 reboots the peer (if required) with the new kernel and runs the functional tests or reliability tests.

For example, master broker 110 sends a request as Request-1:Machine-A to the sub-broker 120. The sub-broker 120 interfacing with intelligent agent now figures out that Request-1 would rather be completed faster if it was processed on two machines. Intelligent agent talks via sub-broker processing unit 280 to the master broker 110. Request-1 would now be divided as Request-1a and Request-1b and “RESUBMITTED” to the master broker internally so that we would have the following scenario: Request-1a:Machine-A; Request-1b:Machine-B.

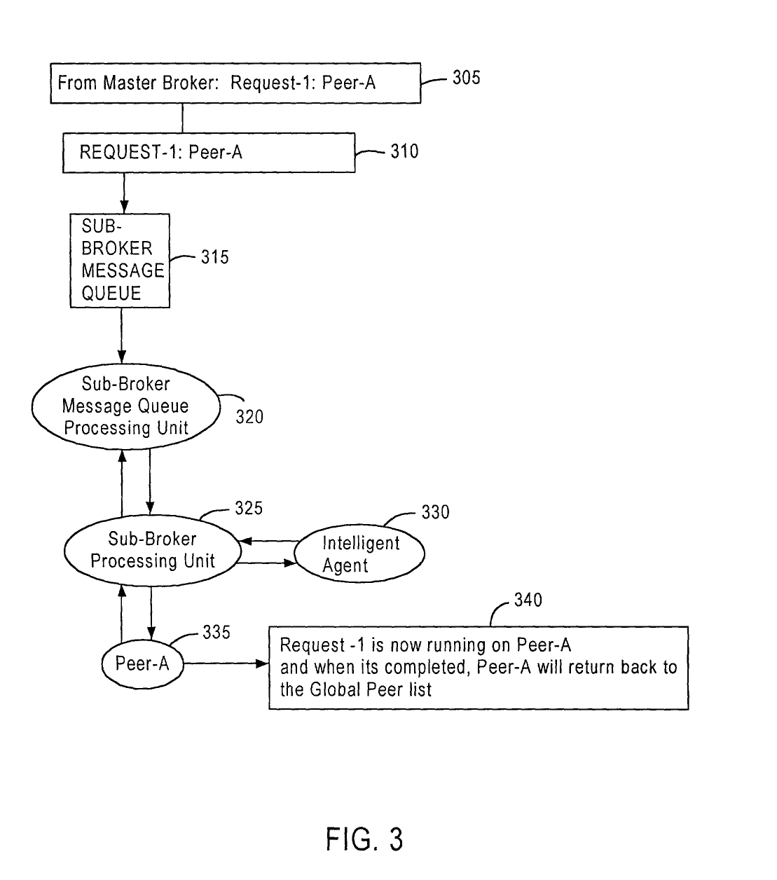

As depicted in FIG. 3, a request:peer pair coming from the master broker 110 (FIG. 1) at step 305 goes through the following stages inside a sub-broker:

1. Request:peer pair at step 310 first goes to the sub-broker message queue 265 at step 315 where it is queued;

2. Then the request processed by the sub-broker message processing unit 270 at step 320 to make sure this sub-broker 120 (FIG. 1) can perform or run the request on that peer; and

3. The sub-broker processing unit 280 at step 325 along with “intelligent agent” at step 330 analyze the request and then schedule the request on peer-A at step 335. At step 340, Request-1 is now running on Peer-A. When Request-1 is completed, Peer-A will return back to the global peer list 250 at step 340.

Otherwise, the request:peer pair is sent back to the master broker 110 (FIG. 1) requesting it be such that we have two Request:peer pairs, i.e., Request-1:Peer-A becomes Request 1a:Peer-A and Request-1 b:Peer-B.

Refer now to FIG. 4 which illustrates a method of performing dynamic peer allocation. As depicted in FIG. 4, the global peer processing unit 260 interfaces with the global peer pool list 250. The global peer pool list 250 includes a free pool list 410, a progress peer pool list 420 and a waiting pool list 430. The global peer processing unit 260 interfaces with Peer-A, Peer-B, Peer-C, Peer-D and Peer-E, each of which have their own respective sub-broker. The above peer list (A, B, C, D and E) form the global peer pool list 250.

It is noted that the sub-broker returns the peer to the waiting peer list 430. The global processing unit picks the peer to append it to the request from free pool list 410, thus forming request-peer pair.

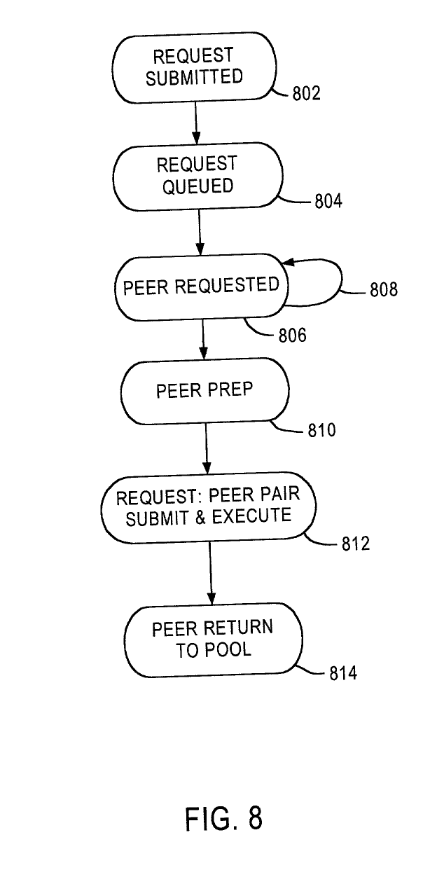

The flow of the request issues from the user is as follows with reference to FIGS. 2 and 8.

1. When a user submits a request 202 at step 802, the request gets submitted to the master message queue 230 of master broker 110 in step 804.

2. The master queue processing unit 240 processes the requests in the master message queue 230 at step 804. The flow proceeds to step 806.

3. At step 806, the master queue processing unit 240 sends a message to the global peer processing unit 260 asking it to get a peer from the global peer pool list 250 (specifically the free pool list 410) and prepare it to satisfy the submitted request. Side loop 808 indicates that there may be a timeout or other mechanism employed to cause additional peer requests if the initial request remains unfulfilled.

4. The flow then proceeds to step 810 and the global peer processing unit 260 and global peer pool list 250 (see FIG. 2) together prepare a peer after qualification that suits the request being submitted. For example, a commands regression test request will be provided with a machine that is prepared with a commands regression test suite. The input to the global peer processing unit 260 is a request and the output is: request:peer pair. The flow proceeds to step 812.

5. At step 812, this request plus peer combination is then sent out to the “specific” sub-broker 120 to start servicing/running the request. For example, the sub-broker 120 for commands would start the installation of a specified (in the request) commands patch and then start regression testing. Execution of the request by sub-broker 120 is described in more detail above with respect to FIG. 3.

6. After the request is serviced by a sub-broker 120, in step 812 the flow proceeds to step 814, wherein the machine is sent back to the global peer pool list 250 by sending a message to the master broker 110 that the peer is free and can be prepared to service another incoming request. Specifically, after the peer finishes running the functional tests, the peers sends a message to global peer processing unit 260 which moves the peer from the progress list 420 to the waiting list 430. Then the global peer processing unit 260 makes sure the peer is qualified for re-use again and moves the peer from waiting list 430 to the free peer pool list 410 which is where it picks up again to service another request.

Each sub-broker module has “complete” knowledge of how a particular piece of software has to be tested, viz., commands testing has to be done using regression tests and commands specific tests on a given set of machines. The master broker 110 is the module that talks to each of the sub-broker modules 120 and does not have the knowledge about commands or library specific testing and specific infrastructure. Any sub-broker 120 can become the master broker 110. This is especially advantageous in the event of a master broker 110 failure. Similarly, any peer can become the master broker. In other words, there is not a single point of failure. Also any peer can become a sub-broker.

The sub-broker module 120 can provide dynamic resource management (machines with respect to regression tests, functional tests, compatibility and standards tests, performance tests, etc).

Examples of what an intelligent agent can do include:

Sending periodic messages to various test rings to update their test rings with the latest “patch bundle” available and determining which machines should be updated;

Updates each machine to include latest patches and validates kernel submittals against this latest depot;

Test kernel changes against commands to ensure that no commands have been broken;

Provide wide variety of software facilities like addition of new functional tests for commands in an “automated” manner user the “intelligent” agent; and

Running code changes against purify, flex lint, standards, compatibility testing, etc.

Today, a user cannot select a machine and run KRT or KFT on it. It is all statically defined and “hard-coded” into the code. The present invention will provide a very dynamically configurable test facility that can then be extended to provide all sorts of mix and match service depending upon hardware/software limitations.

From a user standpoint, the present invention provides testing of an unofficial commands/libc patch for post-release submittal to a clear-case view; testing an official commands patch/libc for post-release submittal to the specific release branch; testing Linux commands on HP-UX operating system release; testing commands to support “dynamic partitions”; and testing future enhancements to existing commands.

Intelligent agents allow computing networks to dynamically work together using intelligent agents. Agents reside on peer computers and communicate various kinds of information back and forth. Agents may also initiate tasks on behalf of other peer systems. These agents can be used with any available infrastructure in use today using a well defined set of application programming interface (API) and messaging protocols. An example of a smart/intelligent agent would be an “ignite server” that wakes up when a request is submitted by a user, matching the requested test with a requested machine.

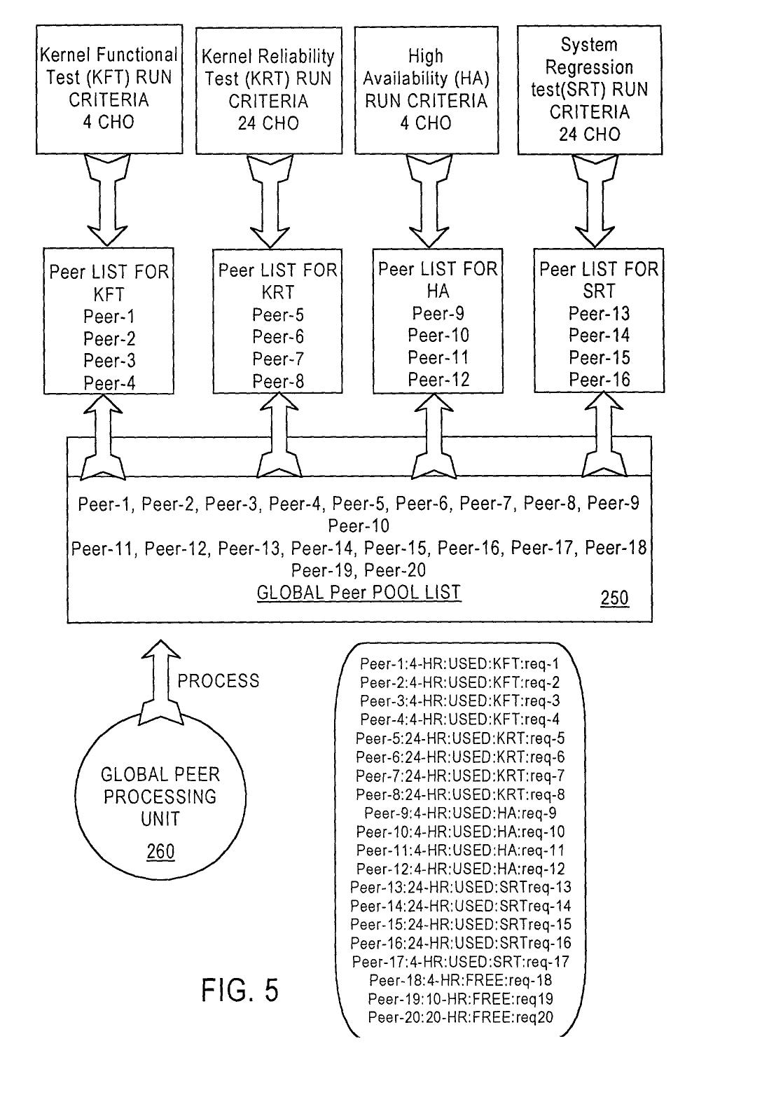

Refer now to FIG. 5 which shows the global peer pool list 250 in greater detail. As illustrated in FIG. 5, the global peer pool list 250 includes a listing of twenty machines of which machines 1-17 are in use whereas machines 18-20 are available and free. As depicted in FIG. 5, there are four different requests for KFT run criteria, a KRT run criteria, an HA run criteria and an SRT run criteria. Their global peer pool list maintains a list of available machines which can run each of these tests. For example, machines 1-4 are available for KFT run machines 5-8 are available for KRT runs, machines 9-12 are available for HA runs and machines 13-16 are available for SRT runs. However, if all four requests are attempted to be run simultaneously, there are no machines available for these requests. A KFT is a kernel functional testing, KRT is kernel regression testing, HA is high availability testing and SRT is system reliability testing.

Returning to FIG. 1, the master broker selects the particular sub-broker used to prepare a machine for a particular request. Once the sub-broker has prepared the machine, the control of the machine is returned back to the master broker.

Types of Requests Submitted to the Master Broker 110

1. Test a commands official patch: this is forwarded to commands sub-broker by the master broker.

2. Test a commands unofficial patch: this is forwarded to the commands sub-broker by the master broker.

3. Test a commands binary object: this is forwarded to the commands sub-broker by the master broker.

4. Test a kernel official patch: this is forwarded to the kernel sub-broker by the master broker.

5. Test a kernel unofficial patch: this is forwarded to the kernel sub-broker by the master broker.

6. Test a kernel binary: this is forwarded to the kernel sub-broker by the master broker.

The above is just an example of small amount of tasks that can be performed by sub-brokers.

The present invention advantageously provides dynamic machine allocation. Dynamic machine allocation can be considered the ability to use test machines to test a particular regression test (static binding of machines to a specific task). The definition of dynamic machine allocation is the ability to prepare a machine to run a specific task which it was previously not able to run. The present invention advantageously provides dynamic allocation of machines to perform “ANY” task assigned to it once a request is submitted as compared to allocating machines to perform “A” task before any request is submitted. The present invention leverages the existing infrastructure to the optimum use. This eliminates the need for statically allocating machines to perform particular testing (viz, regression testing, functional testing, performance testing, etc.

Future Expansion of this Architecture

Load sharing among peers is as follows:

| REQUESTS | PEERS: (Global peer Pool List) |
|---|---|
| Request-1: Perform task X | (Peer-A) Machine-A: |
| Request-2: Perform task Y | (Peer-B) Machine-B: |
| Request-3: Perform task Y | (Peer-C) Machine-C: |

Request-1 will be issued and Machine-A would be “prepared” to perform task X

Request-2 will be issued and Machine-B would be “prepared” to perform task Y

Request-3 will be issued and Machine-C wold be “prepared” to perform task Y

Hence, in the above-scenario, no machines or requests are awaiting or sitting idle. The time taken to prepare machines A, B and C to perform tasks X and Y is very minimal considering the optimized use of machines which are scarce and can be utilized efficiently.

Peer is the same as machine used above and are used interchangeably in some places.

No Single Point of Failure

Typically, a master broker 110 is connected to a sub-broker 120. A sub-broker 120 then becomes part of the peer-to-peer distributed network 100. A sub-broker 120 has to “register” itself to the master sub-broker 110 to enable the master broker 110 to associate/issue a particular request to a particular sub-broker 120. Any sub-broker 120 can become a master sub-broker 110 in an event of failure. This process is not automatic but has to be initiated by the system administrator managing the distributed network. A peer can become the master broker 110 or a sub-broker 120 in the event of a master broker 110 or sub-broker 120 failure. In the event of a failure, when a sub-broker 120 takes over a master broker 110 also, then there is a single system master broker 110 and sub-broker 120 until a peer is identified to act as master broker 110 or a new system to act as master broker. Intelligent agents are prepared to perform a particular task and constantly are in touch with the sub-broker to perform. They are only doing a particular task and thus are limited in the type of task they can perform.

In the above-mentioned scenario, if a sub-broker 120 becomes heavily overloaded, a peer can share the load of the sub-broker 120 and hence two sub-brokers would be sharing the load. The two sub-brokers both work in sync and communicate with the master sub-broker 120. Later on, depending upon the need, the second sub-broker would become a peer again if the network load becomes less. If a request is too heavy and would take time, a sub-broker 120 has the ability to break down the request into multiple units. Say Request-1 is broken down into Request-1a and Request-1b. The sub-broker 120 in turn notifies the master broker 110 that it needs to process Request-1a and Request-1b. Separately and hence: before scenario: Request-1: Peer-A; after scenario: Request-1 is divided into Request-1a and Request-1b. So Request-1a: Peer-A, Request-1b:Peer-B.

In the above scenario, the sub-broker has in some sense acted very intelligently getting input from the intelligent agent that Request-1 would take longer so divide the Request-1 into two requests. This way the sub-broker 120 has the ability to load balance depending upon the usage and depending upon the fact that intelligent agents talk to the master broker and keep track of the load at the master broker. If the load is less at the master broker 110, the intelligent agent would tell sub-broker that it has the privilege to break tasks (logically) into small pieces and hence send them out to different peers rather than a single peer. This also depends upon the request, e.g., if a request cannot be divided into smaller pieces, then the intelligent agent cannot help. The characteristics of a sub-broker and intelligent agent identify whether it can break request into smaller pieces. And hence the significant role played by intelligent agent in this distributed mechanism.

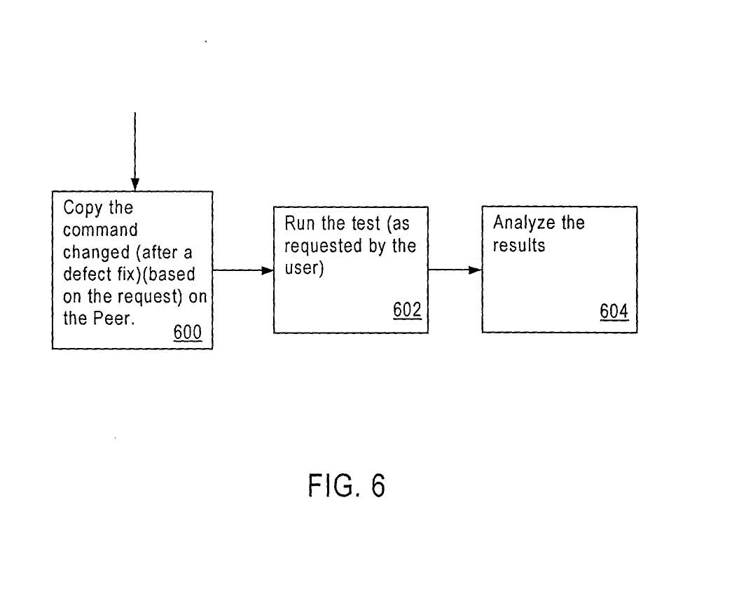

Refer now to FIG. 6 which is an illustration of a flow diagram of patch processing by a sub-broker 120. Based on input from the master queue processing unit 240, the in step 600 the sub-broker 120 copies changed commands, i.e., patches, to the peer for testing. The flow of control proceeds to step 602 where, based on the request provided to the peer from the sub-broker described in detail above, the requested test is performed o the peer. When the test completes, the flow proceeds to step 604 wherein the test results are analyzed for subsequent return to the user.

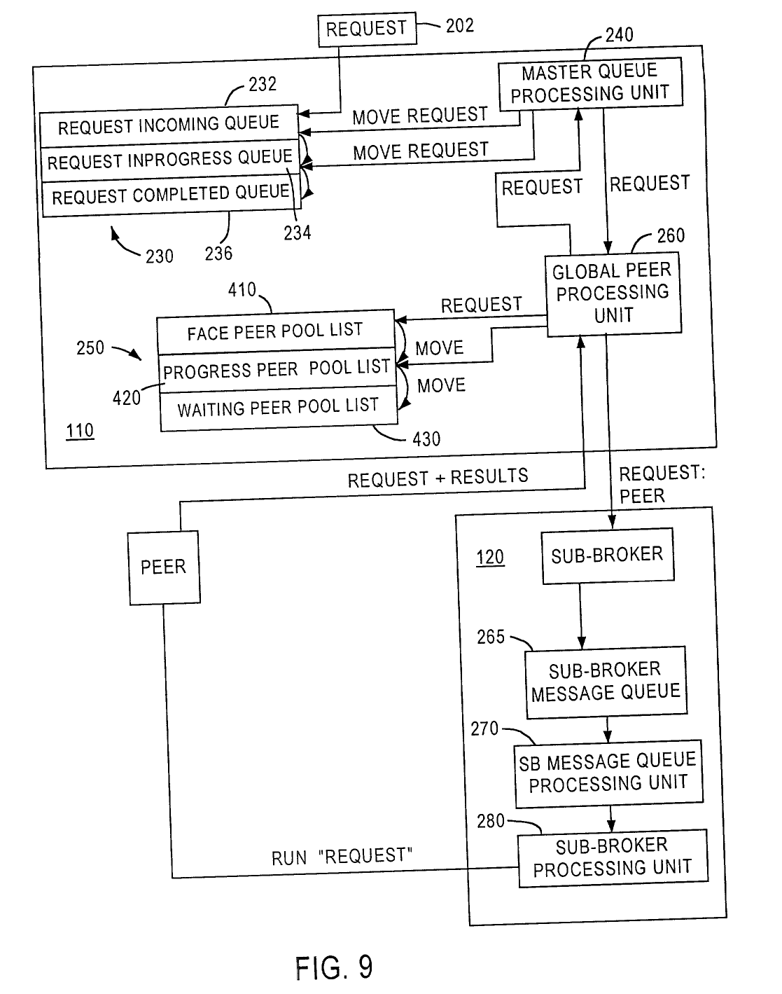

FIG. 9 is a flow diagram of the flow of a request through the system of the present invention.

Hardware Overview

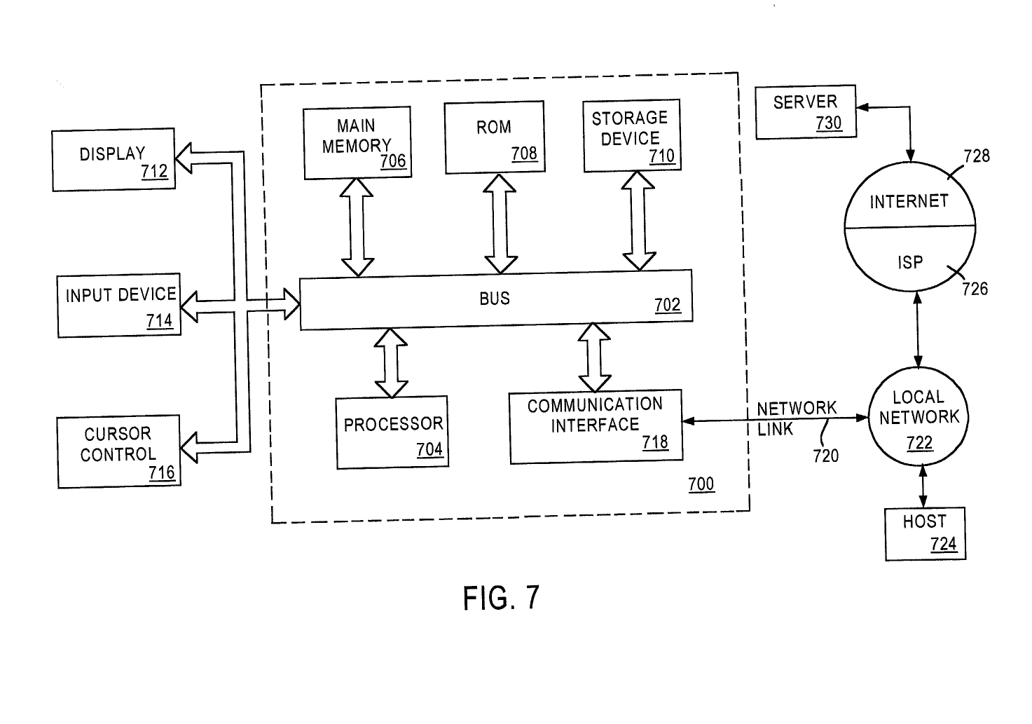

FIG. 7 is a block diagram illustrating an exemplary computer system 700 upon which an embodiment of the invention may be implemented. The present invention is usable with currently available personal computers, mini-mainframes and the like.

Computer system 700 includes a bus 702 or other communication mechanism for communicating information, and a processor 704 coupled with the bus 702 for processing information. Computer system 700 also includes a main memory 706, such as a random access memory (RAM) or other dynamic storage device, coupled to the bus 702 for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to the bus 702 for storing static information and instructions for the processor 704. A storage device 710, such as a magnetic disk or optical disk, is provided and coupled to the bus 702 for storing information and instructions.

Computer system 700 may be coupled via the bus 702 to a display 712, such as a cathode ray tube (CRT) or a flat panel display, for displaying information to a computer user. An input device 714, including alphanumeric and other keys, is coupled to the bus 702 for communicating information and command selections to the processor 704. Another type of user input device is cursor control 716, such as a mouse, a trackball, or cursor direction keys for communicating direction information and command selections to processor 704 and for controlling cursor movement on the display 712. This input device typically has two degrees of freedom in two axes, a first axis (e.g., x) and a second axis (e.g., y) allowing the device to specify positions in a plane.

The invention is related to the use of a computer system 700, such as the illustrated system, to distribute workloads among servers and clients. According to one embodiment of the invention, a peer-to-peer mechanism is provided by computer system 700 in response to processor 704 executing sequences of instructions contained in main memory 706. Such instructions may be read into main memory 706 from another computer-readable medium, such as storage device 710. However, the computer-readable medium is not limited to devices such as storage device 710. For example, the computer-readable medium may include a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave embodied in an electrical, electromagnetic, infrared, or optical signal, or any other medium from which a computer can read. Execution of the sequences of instructions contained in the main memory 706 causes the processor 704 to perform the process steps described below. In alternative embodiments, hard-wired circuitry may be used in place of or in combination with computer software instructions to implement the invention. Thus, embodiments of the invention are not limited to any specific combination of hardware circuitry and software.

Computer system 700 also includes a communication interface 718 coupled to the bus 702. Communication interface 708 provides a two-way data communication as is known. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals which carry digital data streams representing various types of information. Of particular note, the communications through interface 718 may permit transmission or receipt of the requests or commands. For example, two or more computer systems 700 may be networked together in a conventional manner with each using the communication interface 718.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication services through the world wide packet data communication network now commonly referred to as the “Internet” 728. Local network 722 and Internet 728 both use electrical, electromagnetic or optical signals which carry digital data streams. The signals through the various networks and the signals on network link 720 and through communication interface 718, which carry the digital data to and from computer system 700, are exemplary forms of carrier waves transporting the information.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718. In accordance with the invention, one such downloaded application provides for information discovery and visualization as described herein.

The received code may be executed by processor 704 as it is received, and/or stored in storage device 710, or other non-volatile storage for later execution. In this manner, computer system 700 may obtain application code in the form of a carrier wave.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A method of dynamically allocating network resources including a plurality of computers, comprising:
receiving a job request for networked resources;
determining whether a sub-broker can handle the job request and, if no sub-broker can handle the job request, then reject the request and if a sub-broker can handle the request, then prepare a computer having available resources to handle the job request.

2. The method of claim 1, comprising qualifying each of the plurality of computers as either available, not available, or incompetent to handle the job request.

3. The method of claim 1, comprising maintaining an availability list for each of the plurality of computers.

4. The method of claim 1, comprising testing an available computer to handle a job request including regression testing, functional testing, compatibility and standards testing and performance testing.

5. The method of claim 1, further comprising characterizing the received job request and forwarding the job request to one of a chosen plurality of sub-broker to reconfigure a computer to handle the job request.

6. The method of claim 5, wherein the plurality of sub-broker includes a patch queue sub-broker, a pre-release sub-broker, a command sub-broker and a libc sub-broker.

7. The method of claim 1, comprising maintaining a list of sub-brokers.

8. The method of claim 3, comprising maintaining a free peer pool list, an in-progress peer pool list and a waiting peer pool list.

9. The method of claim 8, comprising returning a computer to the free peer pool list after the job request has been completed.

10. The method of claim 8, comprising removing a computer from the free peer pool list and adding the computer to the in-progress peer pool list during execution of the job request.

11. The method of claim 1, wherein a computer is prepared by a global peer processing unit.

12. The method of claim 8, comprising returning a computer to the waiting peer pool list and qualifying the computer to be placed on the free peer pool list.

13. The method of claim 1, comprising determining whether the job request can be handled by one computer, and if necessary, assigning two or more computers to handle the job request.

14. The method of claim 1, comprising registering sub-brokers with a master broker.

15. A system for dynamically allocating network resources, including a plurality of computers, comprising:
a master broker residing on one of said plurality of computers;
at least one sub-broker residing on another one of said computers;
at least one peer from said plurality of computers;
said master broker capable of receiving a job request and determining whether the at least one sub-broker can handle the job request;
if said at least one sub-broker can handle the job request then prepare the computer to perform the job request.
